(19) United States
(12) Patent Application Publication
(10) Pub. No.: US 2010/0313172 A1
(43) Pub. Date: Dec. 9, 2010

(54) VIDEO DISPLAY CONTROL APPARATUS, VIDEO DISPLAY CONTROL METHOD, AND VIDEO DEVICE

(75) Inventor: Takashi HIRAHARA, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/793,605

(22) Filed: Jun. 3, 2010

(30) Foreign Application Priority Data
Jun. 8, 2009 (JP) 2009-137333

(51) Int. Cl. G06F 3/14

(52) U.S. Cl. 715/867

(57) ABSTRACT

In a video display control method of the embodiment, a background image of a moving picture or a still picture is provided on an image display screen, and an on-screen display image is displayed on the screen including the background image. Then, when a first predetermined time period or more has elapsed without any apparatus operation since the on-screen display image is displayed, the on-screen display image is cleared.

When a second predetermined time period or more has elapsed without any apparatus operation since the background image is changed to a still, screen-save processing is executed.

### CROSS-REFERENCE TO RELATED APPLICATIONS

This application is based upon and claims the benefit of priority from Japanese Patent Application No. 2009-137333, filed Jun. 8, 2009; the entire contents of which are incorporated herein by reference.

### FIELD

Embodiments described herein generally relate to a video display control apparatus and video display control method, which execute video display control such as time-out control of an on-screen display image, and display control of a screen saver, and a video device which uses this control method.

### BACKGROUND

In a recent digital playback apparatus, a function of displaying a setting menu (a kind of graphical user interface (GUI)) on a moving picture during playback as an on-screen display image, and a function of reducing a moving picture display area and displaying supplemental information using, e.g., a still picture on a free area formed after reduction together with a reduced moving picture are added as added values of a playback content itself. In the field of a video apparatus, a screen saver is known (Jpn. Pat. Appln. KOKAI Publication No. 2005-94299).

In Jpn. Pat. Appln. KOKAI Publication No. 2005-94299, when the user does not make any operation for a predetermined period of time, TV reception display is automatically switched to display of designated screen saver contents. When a plasma display or CRT is used for this TV reception display, if screen saver contents including a bright still picture are displayed on the display screen for a long period of time, screen burn-in may occur by that still picture part. In case of a screen saver which blacks out the entire screen, such burn-in does not occur. However, in this case, screen saver contents cannot be seen, thus making the user uncomfortable.

A similar phenomenon occurs when a still picture GUI such as a setting menu is displayed on a background image as an on-screen display image. That is, when a screen saver is activated due to suspension of menu operations for a while before completion of apparatus settings using a setting menu, screen burn-in by a setting menu (still picture GUI) part can be prevented, but the setting menu disappears although needed settings are not complete yet, thus making the user uncomfortable in terms of operations (or disturbing user's convenience).

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary block diagram for explaining a video display control apparatus according to an embodiment;

FIG. 2 is an exemplary view for explaining a display example in the apparatus shown in FIG. 1;

FIG. 3 is an exemplary view for explaining an example of setting items in the apparatus shown in FIG. 1; and

FIG. 4 is an exemplary flowchart for explaining the operation of the apparatus shown in FIG. 1.

### DETAILED DESCRIPTION

One aspect of an embodiment is to avoid a state that disturbs user's convenience like that an on-screen display image such as a setting menu disappears despite the intention of the user due to activation of a screen saver before completion of apparatus settings.

In general, according to the embodiment, a video display control apparatus includes: a module (100c, 100f; video display in ST10) configured to provide a background image defined by a moving picture or still picture on an image display screen (400); a module (100a, 100b; GUI display in ST10) configured to display an on-screen display image (400a, 400b) on the screen including the background image; a module (100d, 100h; ST31) configured to clear the on-screen display image (400c) when a first predetermined time period (for example, 5 minutes) or more has elapsed (Yes in ST26) without any apparatus operations (No in ST22) since the on-screen display image is displayed (Yes in ST21) (GUI time-out); and a screen-saver control module (100g; ST17) configured to execute screen-save processing (after screen information immediately before the save processing is stored, display is switched to save screen 400d) when a second predetermined time period (for example, 30 minutes) or more has elapsed (Yes in ST16) without any apparatus operations (No in ST13) since the background image is changed to a still picture (Yes in ST12).

Note that the user can independently set the first predetermined time period (for example, 5 minutes) and the second predetermined time period (for example, 30 minutes), and can change how to operate the on-screen display clear processing and screen-save processing depending on the setting values of the first and second predetermined time periods. For example, when the second predetermined time period is set to be equal to or longer than the first predetermined time period, the screen-save processing is never activated during an on-screen display guaranteed period (until the first predetermined time period elapses) (a No branch timing in ST26). In this case, the screen-save processing is activated after the on-screen display guaranteed period (first predetermined time period) has elapsed (a “Yes” branch timing in ST26).

According to this embodiment, screen saver processing can be executed without disturbing user's convenience.

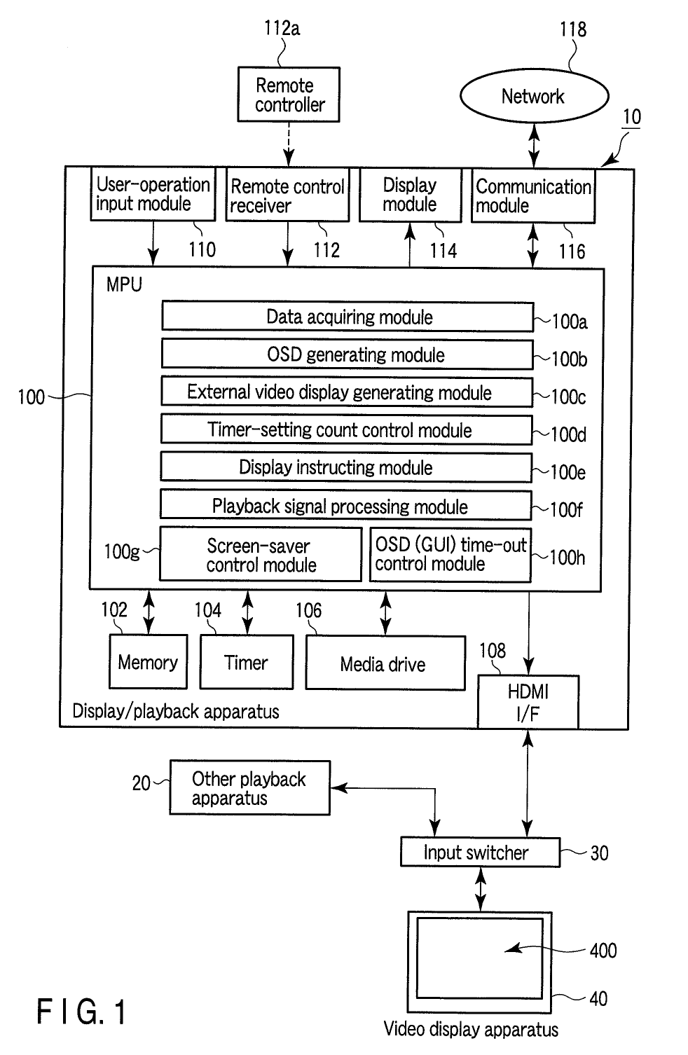

Various embodiments will be described hereinafter with reference to the drawings. FIG. 1 is a block diagram for explaining a video display control apparatus according to an embodiment. This video display control apparatus is embedded in display/playback apparatus (digital video apparatus) 10 as a part of the processing function of a microcomputer (MPU).

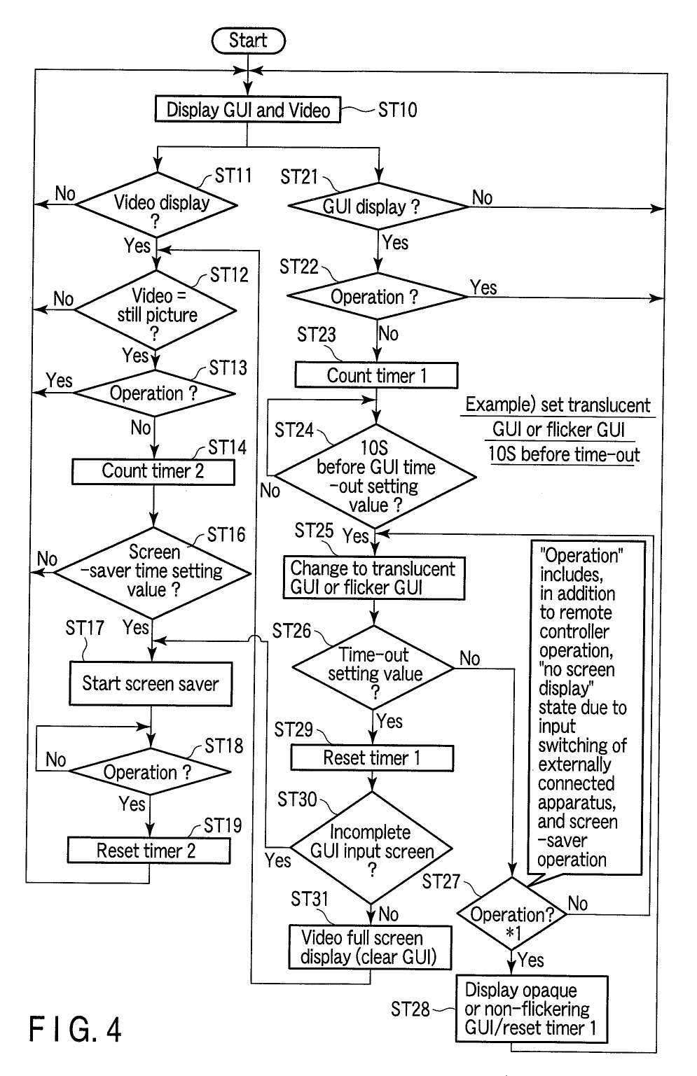

Display/playback apparatus 10 includes MPU 100, memory 102, timer 104, media drive 106 which handles optical disc media such as a DVD or BD (or memory card media), digital AV interface 108 such as a High-Definition Multimedia Interface (HDMI), user-operation input module 110 such as a touch panel, remote control receiver 112 which receives a user-operation instruction from remote controller 112a, display module 114 which displays a video picture and GUI images, and communication module 116 connected to network 118 such as the Internet. Note that memory 102 includes an area for storing firmware (see a flowchart in FIG. 4 to be described later) to be executed by MPU 100, a work area used upon execution of this firmware, and an area for temporarily storing user setting values (time setting values in FIG. 3), screen save data, and the like.

HDMI interface 108 is connected as needed to an HDMI interface of video display apparatus 40 such as a digital TV via input switcher 30. To video display apparatus 40, other playback apparatuses (a DVD player, BD player, set-top box, AV personal computer, computer game machine, etc.) can also be connected via input switcher 30.

MPU 100 includes data acquiring module 100a which acquires data from modules 102 to 116 as needed, OSD generating module 100b which generates on-screen display information (a GUI image such as a setting menu) to be displayed on display module 114 and/or image display screen 400 of video display apparatus 40, external video display generating module 100c which generates display information corresponding to external video information from, e.g., network 118, timer-setting count control module 100d which sets a GUI time-out time, screen saver activation time (operation start time), and the like using timer 104, display instructing module 100e which issues a display instruction to display module 114 and/or video display apparatus 40 based on an operation input or the like from user-operation input module 110 or remote controller 112a, and playback signal processing module 100f which processes a playback signal from media drive 106 or the like.

MPU 100 further includes screen-saver control module 100g which controls a screen-saver operation using timer 104, and OSD time-out control module 100h which controls a time-out of an on-screen display image (GUI image) using timer 104.

In the arrangement shown in FIG. 1, external video display generating module 100c and playback signal processing module 100f configure a module which provides a background image defined by a moving picture or still picture on image display screen 400 (corresponding to video display in ST10 in FIG. 4). Note that the background image includes an external video picture downloaded from the Internet, a DVD/BD video playback video picture, or a still picture pre-stored in apparatus 10. Image display screen 400 includes a screen of a display device such as a plasma display and CRT which may cause burn-in, but it may be a screen of a liquid crystal display (LCD).

Note that various types of video display apparatuses 40 are externally connected to display/playback apparatus 10, and an LCD, organic EL, and the like which are in no risk of burn-in are used in addition to a plasma display and CRT which might cause burn-in. Upon practicing the embodiment, use of video display apparatuses such as an LCD and organic EL which are in no risk of burn-in is not disturbed. In a video display apparatus (for example, an LCD) which is in no risk of burn-in, power savings can be attained by lowering a consumption current of a backlight during a screen saver operation. For this reason, when the embodiment which combines GUI time-out control and screen-saver control is applied to apparatus 10 which uses a display device such as an LCD, a power saving problem can be solved in any way in place of a burn-in problem. In consideration of not only a burn-in problem but also a power saving problem, an LCD or organic EL display is suited to display module 114 to be built in apparatus 10.

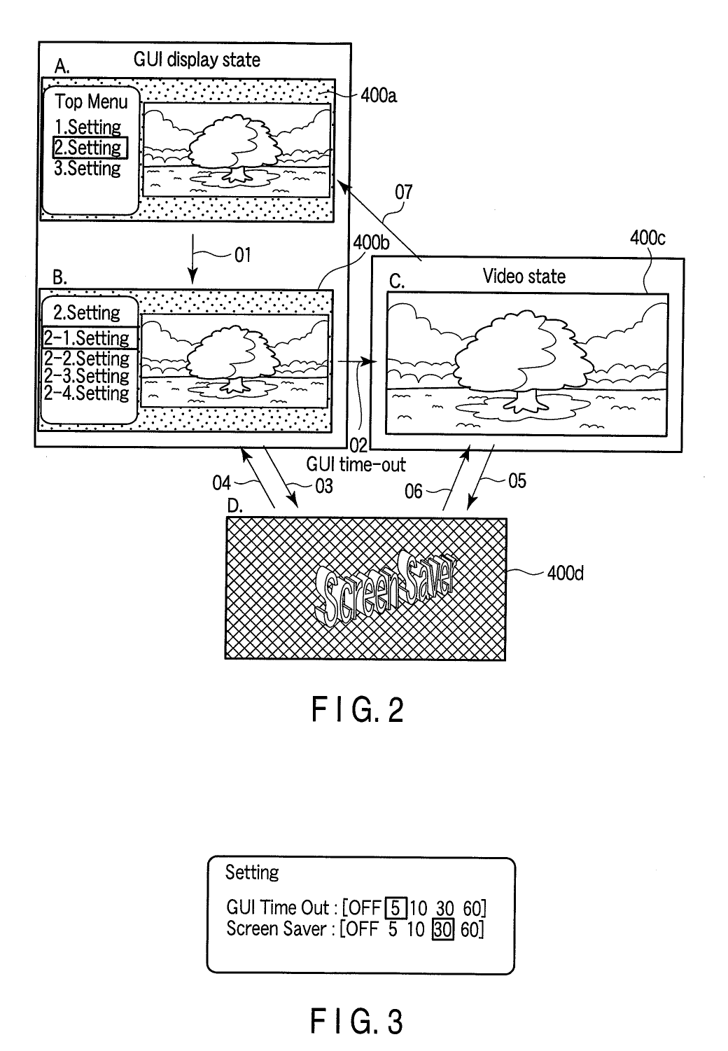

Data acquiring module 100a and OSD generating module 100b configure a module which displays an on-screen display image (400a, 400b in FIG. 2) on the screen including the background image (corresponding to GUI display in ST10 in FIG. 4).

Timer-setting count control module 100d and OSD time-out control module 100h configure a module which clears the on-screen display image (400c in FIG. 2; the background image is displayed on the full screen) when a first predetermined time period (for example, 5 minutes) or more has elapsed (GUI time-out) (Yes in ST26 in FIG. 4) without any apparatus operations (e.g., a remote controller operation) (No in ST22 in FIG. 4) since the on-screen display image is displayed (Yes in ST21 in FIG. 4), irrespective of whether or not the background image is a still picture (ST31 in FIG. 4).

Screen-saver control module 100g configures a screen-saver control module which executes screen-save processing when a second predetermined time period (for example, 30 minutes) or more has elapsed without any apparatus operations (No in ST13 in FIG. 4) since the background image is changed to a still picture (Yes in ST12 in FIG. 4) (ST17 in FIG. 4). Upon execution of the screen-save processing, after screen information (400b or 400c in FIG. 2) immediately before the save processing is stored in memory 102, display is configured to be switched to a save screen (400d in FIG. 2).

FIG. 2 is a view for explaining a display example in the apparatus shown in FIG. 1. Assume that a video playback picture of a video disc (or memory card) (not shown) loaded in media drive 106 is initially displayed on the full screen (400c). In this state, when an external video picture (an arbitrary GUI image) is input from, e.g., network 118 or when the user issues a display instruction of, e.g., a setting menu (GUI) by a remote controller operation, a video picture is reduced in size, and the GUI image is displayed on a free area of the screen (400a) (transition arrow 07). When the user who watches this GUI image selects a second item “Setting” by operating, e.g., a cursor key on remote controller 112a, and presses an enter key of remote controller 112a, the GUI image is further switched to a setting menu (400b) of a lower layer (transition arrow 01).

When the user selects a (2-1)-th item “Setting” by operating, e.g., the cursor key on remote controller 112a, and presses the enter key of remote controller 112a, items that allow the user to independently set a GUI time-out time and screen-saver activation time are displayed as a GUI image. The GUI time-out time (for example, 5 minutes) and screen-saver activation time (for example, 30 minutes) which are set on this GUI image are stored in memory 102 (nonvolatile memory). Timer 104 in FIG. 1 can measure these setting times.

When a screen saver is activated before a GUI time-out, the screen changes to a screen-saver screen (400d) (transition arrow 03). In this case, screen information (400b) immediately before the save processing is stored in memory 102. When the user makes an arbitrary operation (for example, he or she presses any key of remote controller 112a) during the screen-save processing, the screen-saver screen (400d) returns to the screen (400b) stored in memory 102 (transition arrow 04).

On the other hand, when, for example, 5 minutes have elapsed without any user operation while the screen stands still in the state of the setting menu (400b) (the control reaches a GUI time-out), the screen changes to full screen display of the video playback picture (400c) (transition arrow 02). When this full screen display is a still picture (for example, when video moving picture playback is paused), and the screen saver activation time is reached in this still picture state, the screen changes to the screen-saver screen (400d) (transition arrow 05). In this case, screen information (400c) immediately before the save processing is stored in memory 102. When the user makes an arbitrary operation during the screen-save processing, the screen-saver screen (400d) returns to the screen (400c) stored in memory 102 (transition arrow 06).

For example, if a moving picture is played back as video playback on screen 400b in FIG. 2, a conventional screen saver is not activated to perform a screen save operation, and a GUI setting menu part as a still picture, which is displayed simultaneously with that moving picture, may cause burn-in. However, in this embodiment, when a GUI time-out is reached, even when a moving picture is played back as video playback on, e.g., screen 400b, the GUI time-out function works to clear the still picture GUI like screen 400c (transition arrow 02). For this reason, the risk of burn-in caused by the GUI part is cast aside. After the GUI time-out, when the user wants to display the GUI setting menu again, he or she need only issue a GUI display instruction by a remote controller operation to display screen 400a (transition arrow 07), and then change the screen to screen 400b by a menu operation (transition arrow 01).

If no GUI time-out function is included, a screen saver has to be activated to prevent burn-in by a GUI part. In this case, the user cannot see not only the GUI setting menu but also a video picture as a moving picture during playback, thus impairing user's convenience. This embodiment solves this problem by combining two modules, i.e., the GUI time-out and screen saver modules.

FIG. 4 is a flowchart for explaining an example of the operation of the apparatus shown in FIG. 1. A computer program which implements the processing of this flowchart is stored in memory 102 as firmware. Assume that the user issues a video playback instruction by, e.g., operating remote controller 112a. Then, video playback starts, and a video picture is displayed on screen 400 of video display apparatus 40 (400c in FIG. 2) (ST10, Yes in ST11). If a displayed video picture is a moving picture (No in ST12), that video picture is continuously displayed (ST10). If a video picture is changed to a still picture by, e.g., pausing playback (Yes in ST12), and if the user does not perform any operation since then (No in ST13), timer 2 starts time counting (time measurement) (ST14). Note that timer 2 is a counter used to measure a screen-saver activation time, and is a part of the function of timer 104.

If the user does not perform any operation (No in ST13), and before timer 2 reaches the screen-saver activation time (for example, 30 minutes) (No in ST16), the video picture is continuously displayed as a still picture (ST10). If the user does not perform any operation (No in ST13), and if timer 2 reaches the screen-saver activation time (for example, 30 minutes) (Yes in ST16), the screen saver is activated (ST17) (400d in FIG. 2). If the user performs an arbitrary operation during the screen saver operation (Yes in ST18), timer 2 is reset (ST19), and the screen saver is canceled to return to an original display state (ST10) (400c in FIG. 2).

If the user issues an on-screen display instruction of a GUI (setting menu or the like) in the original display state (ST10), a GUI is displayed on screen 400 of video display apparatus 40 as an on-screen display image (ST10, Yes in ST21) (400a in FIG. 2). As long as the user performs operations using this GUI (Yes in ST22), the GUI is displayed together with the video picture (ST10, Yes in ST21) (400b in FIG. 2).

For example, when the user performs slow apparatus operations, and suspends an operation while reading an operation manual (No in ST22), timer 1 starts time counting (time measurement) (ST23). Note that timer 1 is a counter used to measure a time until a GUI time-out, and is another part of the function of timer 104.

In case of the screen saver operation, as soon as the time is reached, the screen-saver screen appears (Yes in ST16). However, in case of the GUI time-out operation, an alert is generated near the time-out timing. That is, the GUI image changes to a translucent image (or it is flickered) and/or an alert sound such as a bleep tone is generated (ST25) 10 seconds before the GUI time-out (Yes in ST24).

If the user performs an arbitrary operation (Yes in ST27) before the GUI time-out is reached (No in ST26), the translucent GUI image returns to an original opaque image (or flickering of the GUI image is stopped to display a non-flickering image), and the alert sound is also stopped if it is generated (ST28). Then, timer 1 is reset (ST28), thus returning to an original display state (ST10) (400b in FIG. 2). Note that the “arbitrary operation” before the GUI time-out includes, in addition to a user's remote controller operation, an HDMI CEC (High Definition Multimedia Interface Consumer Electronics Control) command operation, a state change to display nothing on the screen (no output connection via HDMI interface 108) by switching of input switcher 30 of video display apparatus 40 (an apparatus externally connected to display/playback apparatus 10), a state change to display the screen-saver screen by activation of the screen saver, and so forth.

If the GUI time-out is reached (Yes in ST26), timer 1 is reset (ST29). If the current state is in the middle of an arbitrary input operation using the GUI (Yes in ST30) (the GUI setting is incomplete), the screen-saver processing starts from that timing (ST17) (transition arrow 03 in FIG. 2). If the current state is not in the middle of an input operation using the GUI (No in ST30) (the GUI setting is complete), the GUI image is cleared, and the screen is switched to video full screen display (ST31) (transition arrow 02 in FIG. 2). After the screen is switched to video full screen display, the screen saver is never activated as long as a video picture displayed on the screen is a moving picture. Even after the video picture displayed on the screen is changed to a still picture, the screen saver is never activated as long as the user performs an arbitrary operation (including a GUI operation). After the video picture displayed on the screen is changed to a still picture, if the user does not perform any operation for a predetermined time period (Yes in ST16), the screen saver is activated (ST17).

The example shown in FIGS. 2 to 4 can be briefly summarized as follows. That is, when the GUI time-out setting time (for example, 5 minutes) is shorter than the screen-saver setting time (for example, 30 minutes), if the apparatus is left to stand in the state of screen display 400b, the screen changes to a video full screen display state of screen display 400c, and then changes to screen-saver screen 400d (when a displayed video picture is a still picture).

Conversely, when the GUI time-out setting time is longer than the screen-saver setting time, if the apparatus is left to stand in a state of screen display 400b, the screen changes to a state of screen-saver screen 400d, and then internally changes to video full screen display state 400c while the screen saver is displayed on the screen (the user cannot see this video full screen since it is covered by the screen-saver screen). In this case, since screen-saver screen 400d is displayed, the aim of preventing screen burn-in is already achieved. For this reason, the GUI time-out processing may be skipped (for example, ST23 to ST31 in FIG. 4 are skipped, i.e., the process jumps from No in ST22 to ST14). In this case, when the screen saver is canceled, the state of screen display 400b can be immediately resumed.

When the GUI time-out setting time is set to be longer than the screen-saver setting time, and the GUI time-out processing is not skipped, a GUI time-out may be reached during the screen-saver operation. In this case, when the GUI time-out is reached during the screen-saver operation, screen 400b can be resumed via screens 400c and 400a after the screen saver is canceled.

### <Effects of Embodiment>

a. The screen burn-in prevention function can be provided while avoiding a state in which an on-screen display image such as a GUI setting menu disappears despite the intention of the user due to activation of the screen saver before completion of apparatus operations (i.e., without impairing user's convenience).

b. A combined effect of the two functions, i.e., the GUI display time-out processing and screen-save processing, can be obtained. That is, since the user can designate priority of the display time-out processing and screen-save processing by independently setting these processing times, the screen burn-in prevention function can be flexibly provided in correspondence with a user's use method.

c. A timer count of the GUI display time-out can be reset even in no output connection to video display apparatus (externally connected apparatus) 40 (Yes in ST27 in FIG. 4) (HDMI interface 108 can detect the presence/absence of an output connection to an externally connected apparatus). A display time-out can be avoided from being reached when nothing is displayed on the screen on the side of video display apparatus 40 due to input switching by input switcher 30, and the GUI contents before completion of setting input operations can be held.

d. After the GUI display time-out is reached during the GUI setting input operations, the control can enter the screen-save processing (Yes in ST30 in FIG. 4). Then, the GUI contents before completion of setting input operations can be held by the screen-save processing.

### <Outline of the Embodiment>

In a video display control method according to an embodiment, a background image defined by a moving picture or still picture is provided on an image display screen (video display in ST10), and an on-screen display image is displayed on the screen including the background image (GUI display in ST10). Then, when a first predetermined time period or more has elapsed (Yes in ST26) without any apparatus operations (No in ST22) since the on-screen display image is displayed (Yes in ST21), the on-screen display image is cleared (ST31). When a second predetermined time period or more has elapsed (Yes in ST16) without any apparatus operations (No in ST13) since the background image is changed to a still picture (Yes in ST12), screen-save processing is executed (ST17).

In other words, when the first predetermined time period or more has not elapsed (No in ST26) without any apparatus operations (No in ST22) since the on-screen display image is displayed (Yes in ST21), the processing for clearing the on-screen display image is not executed. Also, when the second predetermined time period or more has not elapsed (No in ST16) without any apparatus operations (No in ST13) since the background image is changed to a still picture (Yes in ST12), the screen-save processing is not executed.

Note that the first predetermined time period (for example, 5 minutes) and the second predetermined time period (for example, 30 minutes) can be independently set. The user can change how to operate the on-screen display clear processing and screen-save processing depending on the setting values of the first and second predetermined time periods.

When the second predetermined time period (for example, 30 minutes) is set to be equal to or longer than the first predetermined time period (for example, 5 minutes), the screen-save processing is never activated during an on-screen display guaranteed period (until the first predetermined time period elapses) (a No branch timing in ST26). In this case, the screen-save processing is activated after the on-screen display guaranteed period (first predetermined time period) has elapsed (a “Yes” branch timing in ST26).

When the second predetermined time period (for example, 5 minutes) is set to be shorter than the first predetermined time period (for example, 10 minutes), a screen-save start period (second predetermined time period) may elapse during the on-screen display guaranteed period (first predetermined time period: a period in which a GUI time-out is not reached) (when the time count start timing of the second predetermined time period is later than that of the first predetermined time period, the second predetermined time period may not elapse within the first predetermined time period). However, even when the second predetermined time period may elapse within the first predetermined time period, when the user is making apparatus operations while observing the on-screen display image (a “Yes” branch timing in ST13, a “Yes” branch timing in ST22), he or she can continue the operations using the on-screen display image without starting the screen-save processing.

While certain embodiments have been described, these embodiments have been presented by way of example only, and are not intended to limit the scope of the inventions. For example, the embodiment can also be practiced in a personal computer, or can be embedded in a digital TV as its function. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modification as would fall within the scope and spirit of the inventions.

What is claimed is:

1. A video display control apparatus comprising:
an image display module configured to display a background image of a moving picture or a still picture on an image display screen;
an on-screen display module configured to display an on-screen display image on the screen comprising the background image;
an on-screen display clearing module configured to clear the on-screen display image if a first predetermined time period elapsed without an apparatus operation since the on-screen display image was displayed; and
a screen-saver controller configured to execute a screen-saver if a second predetermined time period elapsed without an apparatus operation since the background image was changed to the still picture.

2. The apparatus of claim 1, further comprising:
a setting screen display module configured to display a setting screen on the image display screen, the setting screen comprising a first field to set the first predetermined time period and a second field to set the second predetermined time period.

3. The apparatus of claim 1, wherein the screen-saver controller is configured to temporarily store on-screen display screen information during an apparatus operation with the on-screen display image and to execute the screen-saver if the apparatus operation is incomplete and the first predetermined time period elapsed.

4. The apparatus of claim 1, wherein the screen-saver controller is configured to allow the on-screen display image cleared before the screen-saver, and the screen-saver is executed after the on-screen display image is cleared, if the first predetermined time period is shorter than the second predetermined time period.

5. The apparatus of claim 1, wherein the screen-saver controller is configured to execute the screen-saver in prior to clearing the on-screen display image if the first predetermined time period is equal to or longer than the second predetermined time period, and if the second predetermined time period elapsed without an apparatus operation since the background image was changed to the still picture.

6. A video display control method comprising:
displaying a background image comprising a moving picture or a still picture on an image display screen;
displaying an on-screen display image on the screen comprising the background image;
clearing the on-screen display image if a first predetermined time period elapsed without an apparatus operation since the on-screen display image was displayed; and
executing a screen-saver if a second predetermined time period elapsed without an apparatus operation since the background image was changed to the still picture.

7. A video device with an on-screen display function and a screen-saver, the device being configured to be used with an image display screen, the device comprising:
an operator module configured to operate the video device; and
a controller comprising an image display module configured to display a background image of a moving picture or a still picture on the image display screen, an on-screen display module configured to display an on-screen display image on the screen comprising the background image, an on-screen display clearing module configured to clear the on-screen display image if a first predetermined time period elapsed without an apparatus operation since the on-screen display image was displayed, and a screen saver controller configured to execute a screen-saver if a second predetermined time period elapsed without an apparatus operation since the background image was changed to the still picture.
